(19) United States
(12) Patent Application Publication
(10) Pub. No.: US 2011/0283973 A1
(43) Pub. Date: Nov. 24, 2011

(54) FUEL DELIVERY PIPE

(75) Inventors: Kensuke NIWA, Nagoya-shi (JP); Hikaru KIKUTA, Takahama-shi (JP); Yoji TSUZUKI, Nagoya-shi (JP)

(73) Assignee: AISAN KOGYO KABUSHIKI KAISHA, Obu-shi (JP)

(21) Appl. No.: 13/050,373

(22) Filed: Mar. 17, 2011

(30) Foreign Application Priority Data
May 18, 2010 (JP) 2010-114332

(51) Int. Cl. F02M 55/02

(52) U.S. Cl. 123/468

(57) ABSTRACT

A fuel delivery pipe made of resin, comprises: a pipe body internally formed with a fuel passage; an inlet pipe for introducing fuel into the pipe body; a plurality of injector attaching parts for distributing the fuel introduced into the pipe body to a plurality of injectors through the fuel passage; and communication passages for communicating the fuel passage with the injector attaching parts, wherein the pipe body includes an absorbing part formed in a flat planar shape extending in a longitudinal direction of the pipe body, and the communication passages are placed so that respective centers are offset to the absorbing part side than a center of the pipe body.

### CROSS-REFERENCE TO RELATED APPLICATIONS

This application is based upon and claims the benefit of priority from the prior Japanese Patent Application No. 2010-114332, filed May 18, 2010, the entire contents of which are incorporated herein by reference.

### TECHNICAL FIELD

The present invention relates to a fuel delivery pipe for distributing and supplying fuel into injectors in cylinders of an internal combustion engine and, more particularly, to a fuel delivery pipe made of synthetic resin.

### BACKGROUND ART

Heretofore, a fuel delivery pipe has been used to distribute fuel from a fuel tank to injectors provided in cylinders of an internal combustion engine. This fuel delivery pipe includes a pipe body formed with a fuel passage, an inlet pipe for introducing fuel into the pipe body, and a plurality of injector attaching parts for distributing the fuel introduced in the pipe body to the injectors.

During operation of the internal combustion engine, the fuel is repeatedly injected from each injector. At that time, in the fuel delivery pipe, pulsations of the fuel pressure (fuel pressure pulsations) are generated by injection from each injector and different pressure pulsations vibrate sympathetically. Accordingly, the fuel pressure may vary with larger pulsations. If the fuel pressure pulsation becomes larger, accordingly, it causes a fuel injection amount from each injector to vary. This results in unstable control of an air-fuel ratio of the internal combustion engine, which may lead to performance deterioration of the internal combustion engine, cause stop of the internal combustion engine, or generate noise.

Therefore, a fuel delivery pipe conventionally adopts a pulsation damper for restraining fuel pressure pulsations. However, the fuel delivery pipe is apt to increase in size due to the pulsation damper. This causes a problem with an increase in the number of components. Consequently, a fuel delivery pipe made of resin is provided with a straight portion (an absorbing part) as a part of an almost cylindrical pipe body as disclosed in JP 11 (1999)-37380A. The straight portion (the absorbing part) absorbs, by its flexibility, the fuel pressure pulsations, thereby restraining the pulsations.

However, in the aforementioned fuel delivery pipe, a communication passage connecting a fuel passage with each injector attaching part is apart from the straight portion (the absorbing part). Accordingly, it takes long until pressure waves generated in the injectors reach the straight portion (the absorbing part). Thus, the straight portion (the absorbing part) could not be deformed so much and hence could not provide the effect of reducing or damping fuel pressure pulsations.

### SUMMARY OF INVENTION

### Technical Problem

The present invention has a purpose to provide a fuel delivery pipe including an absorbing part with high pulsation absorbing capacity to enhance the effect of reducing fuel pressure pulsations.

### Solution to Problem

To achieve the above purpose, one aspect of the invention provides a fuel delivery pipe made of resin, comprising: a pipe body internally formed with a fuel passage; an inlet pipe for introducing fuel into the pipe body; a plurality of injector attaching parts for distributing the fuel introduced into the pipe body to a plurality of injectors through the fuel passage; and communication passages for communicating the fuel passage with the injector attaching parts, wherein the pipe body includes an absorbing part formed in a flat planar shape extending in a longitudinal direction of the pipe body, and the communication passages are placed so that respective centers are offset to the absorbing part side than a center of the pipe body.

### BRIEF DESCRIPTION OF DRAWINGS

FIG. 1 is a front view of a schematic configuration of a fuel delivery pipe in an embodiment;

FIG. 2 is a bottom view of the schematic configuration of the fuel delivery pipe in the embodiment;

FIG. 3 is a cross-sectional view taken along a line A-A in FIG. 1;

FIG. 4 is a bottom view showing a schematic configuration of a fuel delivery pipe in a modified example; and

FIG. 5 is a cross-sectional view showing the schematic configuration of the fuel delivery pipe in the modified example.

### DESCRIPTION OF EMBODIMENTS

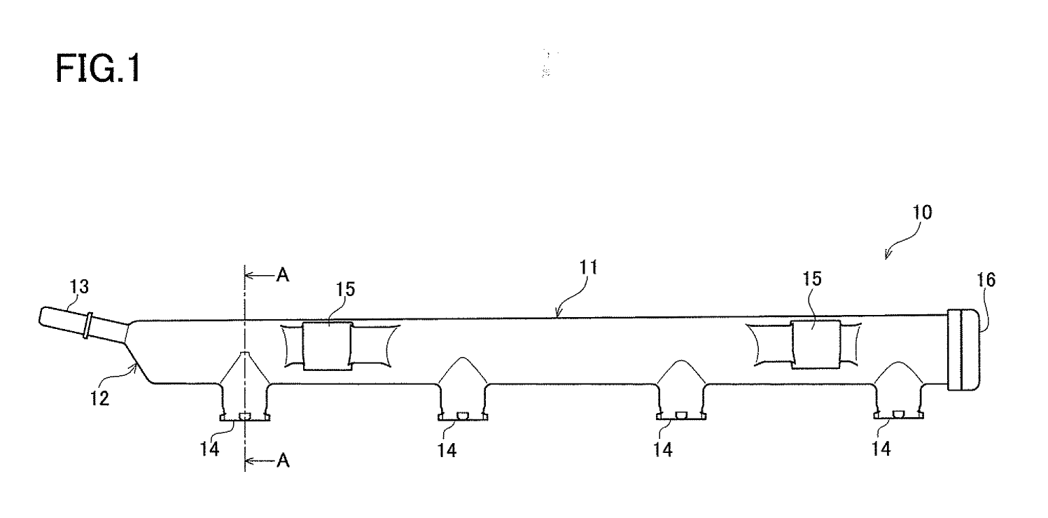

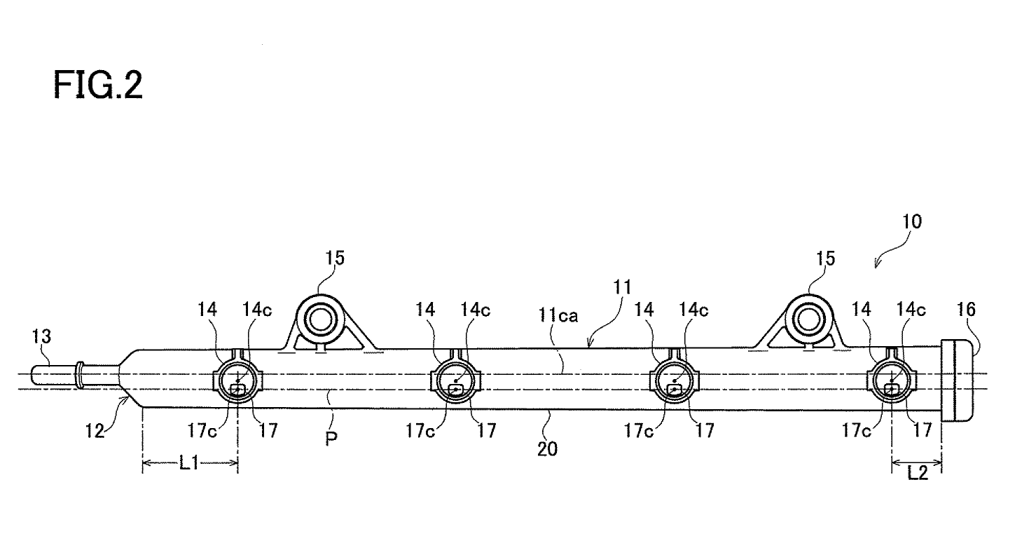

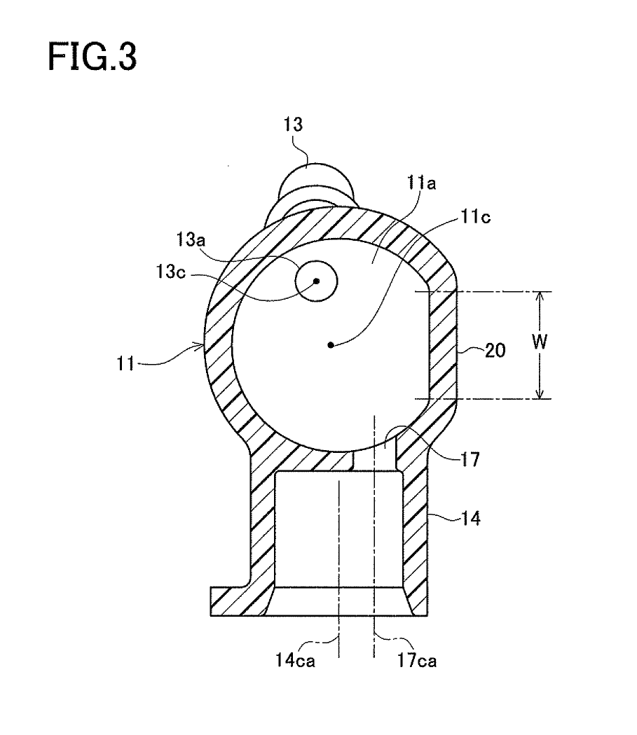

A detailed description of a preferred embodiment of a fuel delivery pipe embodying the present invention will now be given referring to the accompanying drawings. The fuel delivery pipe in this embodiment is explained referring to FIGS. 1 to 3. FIG. 1 is a front view of a schematic configuration of the fuel delivery pipe in this embodiment. FIG. 2 is a bottom view of the same. FIG. 3 is a cross-sectional view of the same taken along a line A-A in FIG. 1.

As shown in FIGS. 1 and 2, a fuel delivery pipe 10 includes a pipe body 11 having an almost cylindrical shape, an inlet pipe 13 integrally formed at one end of the pipe body 11, a plurality (four in this embodiment) of injector attaching parts 14 formed to protrude from a lower side of the pipe body 11, and a pair of mounting flanges 15 formed on the pipe body 11 and spaced in the longitudinal direction of the pipe body 11. This fuel delivery pipe 10 is a resin-molded component made of composite resin mixed with a filler reinforcing material consisting of short fibers. In this embodiment, the composite resin is preferably polyamide resin such as 66 nylon and the filler reinforcing material is preferably glass fibers. At the other end of the pipe body 11, a closing cap 16 is welded.

The pipe body 11 is internally formed with a fuel passage 11a as shown in FIG. 3. This pipe body 11 includes an absorbing part 20 formed in a flat planar shape in a longitudinal direction of the pipe body 11 (see FIG. 2). The absorbing part 20 takes a narrow rectangular form extending in the longitudinal direction. Thus, the pipe body 11 includes a flat plane as a part of a cylindrical form (see FIG. 3). This absorbing part 20 is so flexible as to bend or warp to thereby absorb fuel pressure pulsations. In this embodiment, the absorbing part 20 is provided in a position opposite the mounting flanges 15.

The absorbing part 20 is designed so that the lengths L1 and L2 of end portions of the absorbing part 20 (see FIG. 2) are longer than the width W of the absorbing part 20 (see FIG. 3), that is, designed to meet relations of L1>W and L2>W. Further, the end-portion lengths L1 and L2 are determined so that the length L1 of the end portion close to the inlet pipe 13 is longer than the length L2 of the other end portion close to the closing cap 16, that is, determined to meet a relation of L1>L2. The length L1 is a size in the longitudinal direction from a left end of the absorbing part 20 to a center 14c of a leftmost one of the injector attaching parts 14 in FIG. 2. The length L2 is a size in the longitudinal direction from a right end of the absorbing part 20 to a center 14c of a rightmost one of the injector attaching parts 14 in FIG. 2. Further, the width W of the absorbing part 20 is a size in a short-side direction of the absorbing part 20 (a direction perpendicular to the longitudinal direction).

Each injector attaching part 14 is formed in an almost cylindrical shape (see FIG. 2) branching off from the pipe body 11 and opening downward as shown in FIG. 1. In each injector attaching part 14, an injector is inserted and fixed. The injector attaching parts 14 are communicated with the fuel passage 11a through respective communication passages 17. Accordingly, the injector attaching parts 14 are able to distribute fuel introduced in the fuel passage 11a of the pipe body 11 to respective injectors.

Herein, each communication passage 17 is placed with its center 17c being offset to the absorbing part 20 than a center 11c (an central axis 11 ca) of the pipe body 11. Accordingly, each communication passage 17 can be arranged close to the absorbing part 20. Because of the presence of the absorbing part 20, the center 11c (the central axis 11 ca) of the pipe body 11 is slightly displaced to the left in FIG. 3 (upwards in FIG. 2) than a center (a central axis) of a pipe body formed with no absorbing part.

Further, each communication passage 17 is placed with the center 17c being offset to the absorbing part 20 than the center 14c (a central axis 14ca) of each injector attaching part 14.

The inlet pipe 13 is integral with the pipe body 11 through the joint portion 12 as shown in FIGS. 1 and 2. The inlet pipe 13 is communicated with the fuel passage 11a of the pipe body 11 through an inlet port 13a (see FIG. 3). This inlet port 13a is provided so that its center is positioned off the plane P (see FIG. 2) including all central axes 17ca of the communication passages 17.

Such inlet pipe 13 is designed to have an internal diameter smaller than an internal diameter of the pipe body 11 so that the inlet pipe 13 is directly connected with one end of a fuel supply hose. The other end of the fuel supply hose is connected to a fuel pipe leading to a fuel pump. Accordingly, fuel is introduced into the fuel passage 11a of the pipe body 11 through the inlet pipe 13.

The mounting flanges 15 are used to secure the fuel delivery pipe 10 to an engine with bolts or the like. Specifically, the fuel delivery pipe 10 is fixed to the engine through the mounting flanges 15 so that the injector attaching parts 14 face downward as shown in FIG. 1.

Operations of the above fuel delivery pipe 10 will be explained below. When the fuel pump is activated, the fuel is supplied to the fuel passage 11a of the fuel delivery pipe 10 through the inlet pipe 13. When the engine is started, the fuel supplied to the fuel passage 11a is distributed to the injector attaching parts 14, and the distributed fuel is repeatedly injected from each injector. At that time, in the fuel delivery pipe 10, fuel pressure pulsations are caused by injection from each injector. However, the absorbing part 20 warps or bends under the effect of the pulsations, thereby absorbing the pulsations.

In the fuel delivery pipe 10, the pipe body 11 is formed with the absorbing part 20 and each communication passage 17 is provided offset to the absorbing part 20 side than the center 11c (the central axis 11ca) of the pipe body 11. Therefore, the distance from each communication passage 17 to the absorbing part 20 is short, allowing pressure waves from the injectors to relatively more rapidly reach the absorbing part 20. Accordingly, the pressure waves collide against the absorbing part 20 while attenuation is small (i.e., the pressure is high), thus deforming the absorbing part 20 with a large amount of deformation. As a result, the pulsation absorbing capacity of the absorbing part 20 is enhanced and therefore the effect of reducing the fuel pressure pulsations can be improved.

Furthermore, each communication passage 17 is placed offset to the absorbing part 20 side than the center 14c (the central axis 14ca) of each injector attaching part 14. Therefore, the fuel pressure pulsations associated with pressure waves from the injectors are transmitted into the fuel passage 11a through the communication passages 17 after the fuel waves collide against the inner walls of the injector attaching parts 14. Thus, the fuel pressure pulsations are not transmitted directly into the fuel passage 11a through the communication passages 17. Consequently, pulsation waves to be transmitted into the fuel passage 11a through the communication passages 17 are reduced or attenuated. The absorbing part 20 can therefore reliably absorb the fuel pressure pulsations and hence surely improve the fuel pressure pulsation reducing effect.

The inlet port 13a of the inlet pipe 13 is provided off the plane P including all the central axes 17ca of the communication passages 17. This makes it possible to prevent the pressure pulsations generated by injection from the injectors from being transmitted to the fuel supply hose and the fuel pipe connected to a fuel tank.

Since the end-portion lengths L1 and L2 and the width W of the absorbing part 20 meet the relations of L1>W and L2>W, furthermore, the absorbing part 20 can also be reliably warped or bent even at both end portions. This enhances the pulsation absorbing capacity of the absorbing part 20, thereby further improving the fuel pressure pulsation reducing effect.

The end-portion lengths L1 and L2 also meet the relation of L1>L2 as mentioned above. The absorbing part 20 can therefore provide an enhanced effect of reducing pressure pulsations which may be transmitted to the inlet pipe 13. Accordingly, it is possible to prevent the pressure pulsations from being transmitted to the fuel supply hose and the fuel pipe connected to the fuel tank through the inlet pipe 13.

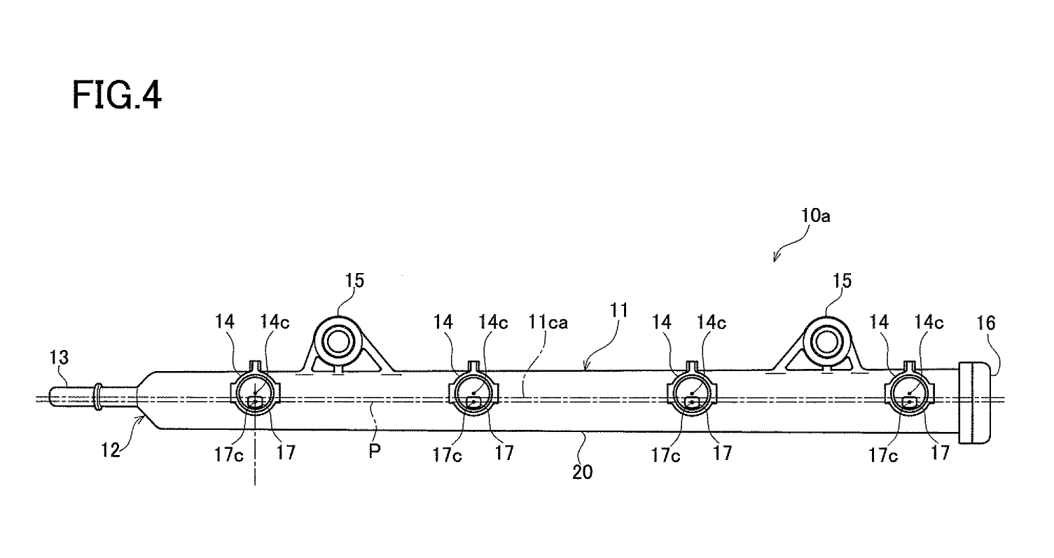

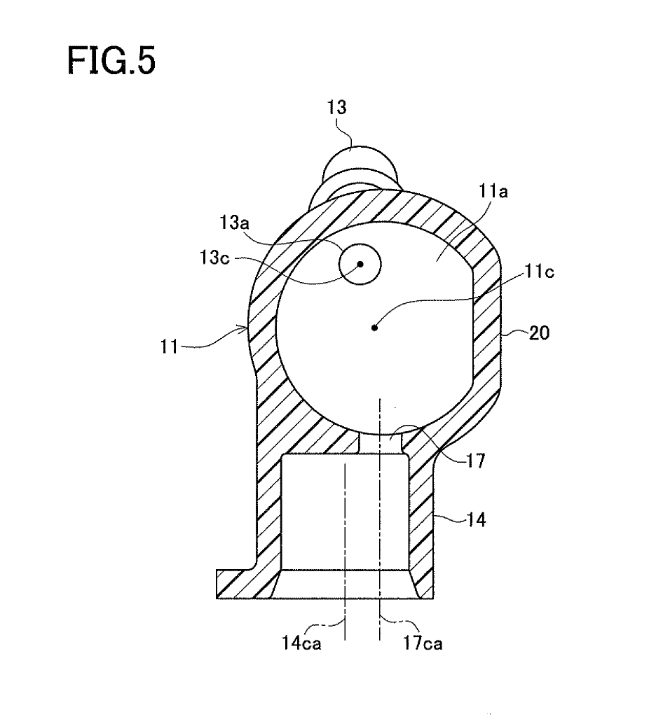

Here, a modified example will be explained referring to FIGS. 4 and 5. FIG. 4 is a bottom view of a schematic configuration of a fuel delivery pipe in this modified example. FIG. 5 is a cross-sectional view of the same. It is to be noted that FIG. 5 corresponds to FIG. 3. The following explanation is given with a focus on differences from the aforementioned fuel delivery pipe 10 by omitting the details of similar or identical parts to those of the fuel delivery pipe 10 and assigning the same reference signs thereto.

In the fuel delivery pipe 10a in this modified example, as shown in FIG. 4, injector attaching parts 14 are placed in positions deviated toward mounting flanges 15 relative to a central axis 11ca of a pipe body 11. According to this placement, as shown in FIG. 5, the position of each communication passage 17 is slightly different from that in the aforementioned fuel delivery pipe 10. To be concrete, as compared with the fuel delivery pipe 10, each communication passage 17 is placed closer to a center 11c of the pipe body 11.

Even such fuel delivery pipe 10a can achieve substantially the same operations and effects as the aforementioned fuel delivery pipe 10.

According to the fuel delivery pipe 10 (10a) in the embodiment explained in detail above, each communication passage 17 is placed offset to the absorbing part 20 side than the center 11c (the central axis 11ea) of the pipe body 11 and the center 14c (the central axis 14ca) of the each injector attaching part 14. Further, the end-portion lengths L1 and L2 and the width W of the absorbing part 20 meet the relations of L1>W, L2>W, and L1>L2. The above configurations can enhance the pulsation absorbing capacity of the absorbing part 20, so that the fuel pressure pulsation reducing effect in the fuel delivery pipe 10 (10a) can be improved.

The above embodiments are mere examples and do not limit the scope of the invention. The invention may be embodied in other specific forms without departing from the essential characteristics thereof. For instance, the above embodiment includes four injector attaching parts 14 and two mounting flanges 15. The number of injector attaching parts and the number of mounting flanges may be increased or decreased appropriately according to the specification of an engine.

1. A fuel delivery pipe made of resin, comprising:
a pipe body internally formed with a fuel passage;
an inlet pipe for introducing fuel into the pipe body;
a plurality of injector attaching parts for distributing the fuel introduced into the pipe body to a plurality of injectors through the fuel passage; and
communication passages for communicating the fuel passage with the injector attaching parts,
wherein the pipe body includes an absorbing part formed in a flat planar shape extending in a longitudinal direction of the pipe body, and
the communication passages are placed so that respective centers are offset to the absorbing part side than a center of the pipe body.

2. The fuel delivery pipe according to claim 1, wherein the communication passages are placed so that respective centers are offset to the absorbing part side than centers of the injector attaching parts.

3. The fuel delivery pipe according to claim 2, wherein the injector attaching parts are placed offset so that respective centers are offset to the absorbing part side than the center of the pipe body.

4. The fuel delivery pipe according to claim 1, wherein the inlet pipe includes an inlet port provided so that its center is positioned off a plane including central axes of the communication passages.

5. The fuel delivery pipe according to claim 1, wherein an end-portion length from an end of the absorbing part to a center of the injector attaching part placed in an end portion of the pipe body is larger than a width of the absorbing part.

6. The fuel delivery pipe according to claim 5, wherein
the pipe body includes one end that is formed with the inlet pipe and the other end that is closed, and
the end-portion length is longer in an end portion formed with the inlet pipe than the other end portion closed.

7. The fuel delivery pipe according to claim 1, wherein the pipe body includes a mounting flange, and the absorbing part is placed opposite the mounting flange.

8. The fuel delivery pipe according to claim 1, wherein an internal diameter of the inlet pipe is smaller than an internal diameter of the pipe body.
